(19) United States
(12) Patent Application Publication
(10) Pub. No.: US 2015/0334991 A1
(43) Pub. Date: Nov. 26, 2015

(54) Invisible Shield Dog Collar

(71) Applicant: Michael Steven Foley, Kingston, TN (US)

(72) Inventor: Michael Steven Foley, Kingston, TN (US)

(21) Appl. No.: 14/489,394

(22) Filed: Sep. 17, 2014

Related U.S. Application Data
(60) Provisional application No. 61/888,489, filed on Oct. 8, 2013.

(51) Int. Cl. A01K 15/02; A01K 27/00

(52) U.S. Cl. CPC A01K 15/021; A01K 27/001; A01K 27/009

(57) ABSTRACT

A pet collar designed to deter pets from chewing their own collar or the collars of other pets in two. This pet collar may be used as a training collar to prevent collar chewing. The pet collar is manufactured or modified to include electrical conductors that extend the length of the collar and arranged in a pattern so that anywhere the pet's mouth or tongue touches the collar it will contact at least 2 conductors that are connected to opposite polarities of the battery, which will deliver a low voltage, low current, mild electrical shock to the pet's mouth or tongue. This collar does not require the trainer to be present while the pet is being trained.

### CROSS-REFERENCE TO RELATED APPLICATIONS

Not Applicable

### BACKGROUND OF THE INVENTION

The invisible shield dog collar is a chew deterrent collar for pets that want to chew on collars. It is designed to prevent and also train animals (such as dogs or cats) not to chew their own collar or another animal's collar. I came up with this idea when chemical spray chew deterrents failed to stop my own dog from chewing collars in two.

### SUMMARY OF THE INVENTION

The invisible shield dog collar is to be used when you have two or more animals in the same area, where one or more of the animals chews the collar off of the other animal, or if you have a single animal that chews his own collar.

Advantages of the invisible shield dog collar over chemical chew deterrents: The battery on the invisible shield dog collar can last for a year or more where sprays need to be reapplied daily. There is no chemical exposure to the pets.

### BRIEF DESCRIPTION OF THE DRAWINGS

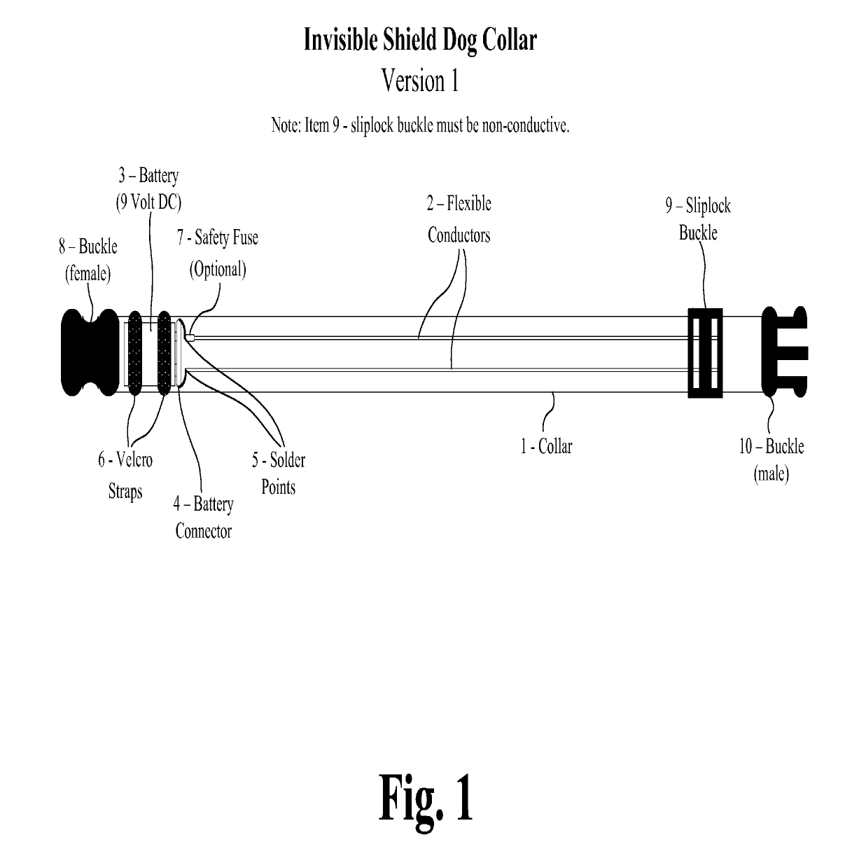

The drawing on page 1 of 3, FIG. 1 is of a pet collar with non-conductive fasteners and non-conductive slip buckle for adjustment that has been modified to include 2 parallel flexible conductors that are attached to the collar and connected to opposite polarities of a 9 volt dc battery by way of a snap on battery connector. This drawing includes a fuse that is optional.

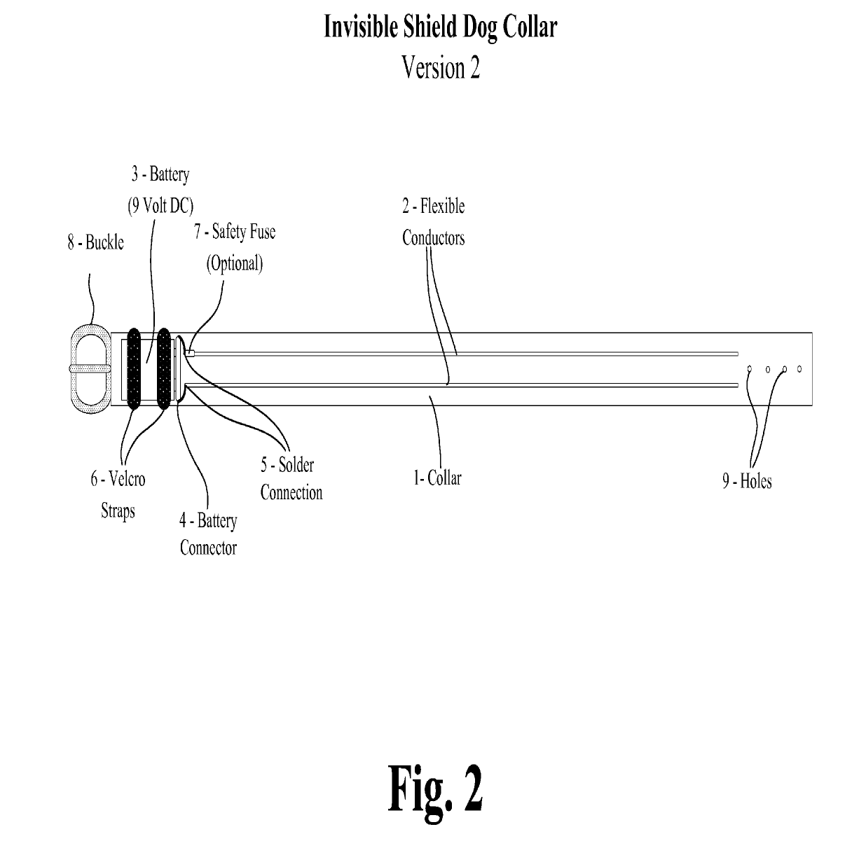

The drawing on page 2 of 3, FIG. 2 is of a pet collar with a buckle on one end and holes on the other end for adjustment and has been modified to include 2 parallel flexible conductors that are attached to the collar and connected to opposite polarities of a 9 volt dc battery by way of a snap on battery connector. This drawing includes a fuse that is optional.

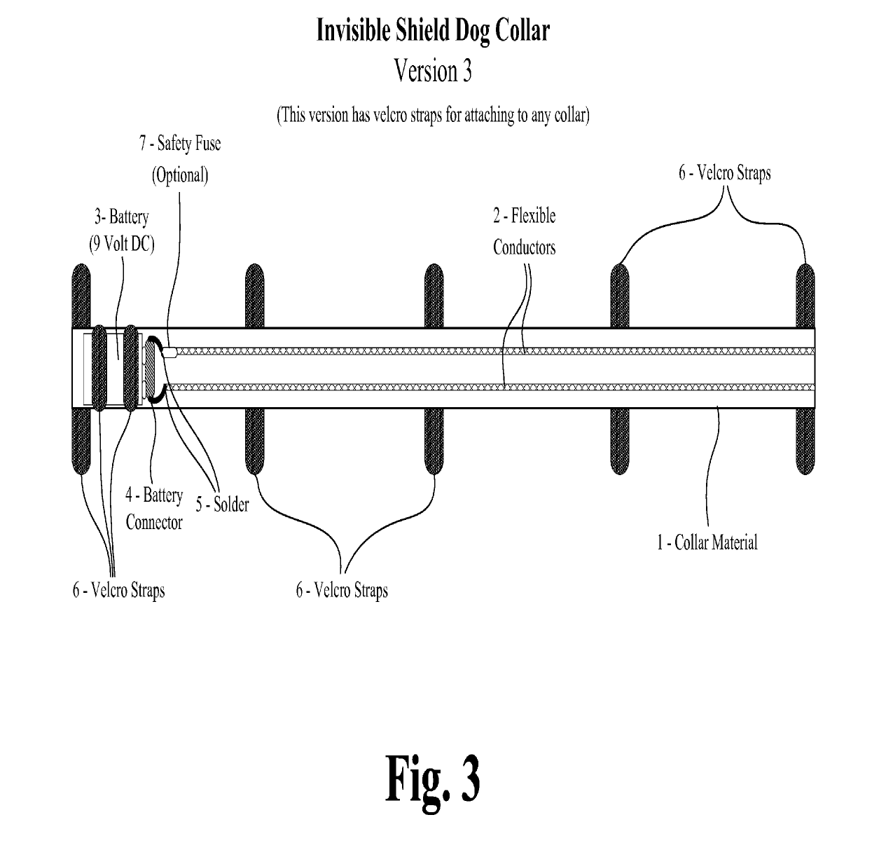

The drawing on page 3 of 3, FIG. 3 is of a pet collar with velcro fasteners spaced evenly along the length of the collar and has been modified to include 2 parallel flexible conductors that are attached to the collar and to opposite polarities of a 9 volt dc battery by way of a snap on battery connector. This collar has velcro straps that enable it to be attached to an existing collar, such as an electronic shock collar. This could prevent other animals from chewing the shock collar in two, which would prevent accidental loss of the collar that the “invisible shield dog collar” is attached to. This drawing includes a fuse that is optional.

### DETAILED DESCRIPTION OF THE INVENTION

The invisible shield dog collar has 2 or more flexible conductors attached to the collar and extending the length of the collar, where one end of each adjacent conductor is attached to the opposite polarity (+/−) of a low voltage dc battery and arranged in such a fashion that anywhere the animal's mouth or tongue comes in contact with the conductors on the collar, their mouth/tongue will provide a path for electrical current flow between the battery terminals, the animal will receive a mild electrical shock that will feel like a mild tingling or pinching sensation that will deter the animal from chewing the collar in two.

How to use the collar: Place the collar on the animal/s that are in the same area as the animal that chews collars. Leave the collar on the animal around 5-7 days. After that time you can switch back to a standard collar and the animal should be trained, not to chew collars. If the animal should revert back to chewing collars after a period of time, just simply place the “Invisible Shield Dog Collar” back on another animal that is in the area with the problem animal/s. Retrain the animal by leaving the collar on the other animal/s for a few days or as long as needed.

How to Manufacture the “Invisible Shield Dog Collar”

Materials required.
1. Collar material (a pre-manufactured collar may be used in place of items 1 & 2)
2. Male and female buckles/fasteners and slip lock buckle
3. Flexible conductors
4. Velcro or battery holder
5. 9v battery (battery types and sizes my vary, battery voltage may vary from 3 volts to 12 volts)
6. Snap on 9v battery connector (other connector types may be used on other battery types)
7. Solder
8. Thread
9. Fuse (fuse is optional)

Use a pre-manufactured collar or fabricate a collar by cutting collar material to desired length, and then cut a plurality of at least 2 strips of the flexible conductors approximately 2 inches shorter than the desired length of the collar. Attach each of the flexible conductors to the collar material, in a fashion such as parallel, spacing them so they cannot come in contact with each other. Spacing will vary depending on the size of collar that is being manufactured or used. Spacing should be such that when an animal tries to bite the collar, the animal's mouth or tongue easily contacts at least 2 of the conductors that will be electrically connected to opposite polarities of a battery.

Then attach a fastener/battery holder to one end of the collar material, velcro strips may be used to hold the battery in place, if velcro is used, attach it perpendicular to the collar and long enough to reach around a 9v battery, near one end of the flexible conductors. Then solder the fuse (fuse is optional) if used to one of the flexible conductors, solder the battery connector wires to one of the flexible conductors and the other battery connector wire to the end of the fuse. If no fuse is installed, just solder the battery connector (red +) wire to one of the flexible conductors and solder the other battery connector (black −) to the other flexible conductor.

If a pre-manufactured collar was not used, then attach a male fastener to one end of the collar material and a female fastener to the other end of the collar material. Install a 9v battery using a battery holder or velcro to secure it to the collar, insure that the metal case of the battery does not touch the two parallel conductors, the collar is now ready to use. Although a range of battery sizes and types may be used, a 9 volt dc battery was used in this example because they are readily available, relatively cheap and produce the expected results.

What is claimed:

1. A pet collar comprising, a modified or fabricated pet collar having plurality of flexible conductors arranged in a fashion (such as parallel) and attached to the collar, a battery (3-12 volt direct current), and a battery connector that is connected to each of the flexible conductors and to the battery.

2. A pet collar comprising, a collar that has no buckles, but has several fasteners such as (velcro strips) attached perpendicular to the collar and evenly spaced with enough length to attach to an existing collar (such as an electronic shock collar) with a plurality of flexible conductors arranged in a fashion (such as parallel) and attached to the collar, a battery (3-12 volt direct current), a battery connector that is connected to each of the flexible conductors and to the battery.

3. The pet collar of claims 1 and 2, wherein is placed on an animal such as dogs or cats to prevent the animal that is wearing the collar and other animals from chewing the collar in two.

4. The pet collar of claims 1 and 2, when an animal's mouth or tongue comes in contact with the conductors on the collar, this completes an electrical circuit that allows a very minute amount of electrical current to flow through the animal's mouth/tongue, which causes a mild tingling or pinching sensation to the animal's mouth/tongue that deters the animal from chewing the collar.

5. The flexible conductors of claims 1 and 2, wherein are a minimum of 2 and are arranged so that every other conductor is connected to the opposite polarity of a battery.

6. The flexible conductors of claim 1 and 2, wherein only one end of each conductor is connected to each of the battery terminals, the opposite end of each flexible conductor is not connected.

7. The flexible conductors of claims 1 and 2, wherein are attached to the collar, with a method comprising sewing with thread.

8. The invisible shield of the title, wherein is provided by the potential energy stored in the battery of claim 11, that will be released into the animals mouth or tongue when it contacts the adjacent flexible conductors of claim number 8.
